(19) United States
(12) Patent Application Publication
(10) Pub. No.: US 2015/0056952 A1
(43) Pub. Date: Feb. 26, 2015

(54) METHOD AND APPARATUS FOR DETERMINING INTENT OF AN END-USER IN A COMMUNICATION SESSION

(71) Applicant: VONAGE NETWORK LLC, Holmdel, NJ (US)

(72) Inventors: Ido Mintz, Burgata (IL); Roni Salfati, Hod Hasharon (IL)

(73) Assignee: VONAGE NETWORK LLC, Holmdel, NJ (US)

(21) Appl. No.: 13/973,488

(22) Filed: Aug. 22, 2013

(51) Int. Cl. H04W 12/06; H04M 1/725

(52) U.S. Cl. CPC H04W 12/06; H04M 1/72569
USPC 455/411; 455/563; 455/418

(57) ABSTRACT

Methods and apparatus for determining intent of an end-user in a communication session are provided herein. In some embodiments, a method determining intent of an end-user in a communication session through voice analysis may include establishing a voice communication session between a first user device and a second user device, performing a voice analysis process to determine whether the end-user intended to establish the voice communication session, and determining whether to permit voice communications over the established voice communication session based on the voice analysis process performed, wherein all voice communications from the first user device is prevented from being transmitted over the established voice communication session at least until the voice analysis process has completed.

### BACKGROUND OF THE INVENTION

1. Field of the Invention

Embodiments consistent with the present invention generally relate to establishing voice communication sessions, and more specifically, to determining intent of an end-user in a communication session through voice analysis.

2. Description of the Related Art

The evolution of mobile phones to smart phones has changed the way people communicate and use their phones. There is an increased demand in instant communication given the proliferation of the smart phone in society that has made the device critical in everyday life. Along those lines, it is equally critical to ensure a communication is actually from a particular user and not just the device of the user or an account registered to the user.

Scenarios where user authentication may be compromised is very commonplace. For instance, a user may have a phone that is lost or stolen. In another instance, the phone may be accidentally dialed via inadvertent activation of buttons or touchscreen areas (a phenomenon referred to as “pocket dialing”). Often, a phone is given to a child as a temporary toy with a video or video game playing that can result in a misdial or unintentional communication session (e.g., email, text, phone call, video call, and the like). In such examples, there may also be accidental virtual purchases or incurred charges from the mobile device. Recently, there are viruses infecting mobile devices that may be able to initiate or accept communication sessions that are not originating from the user.

Accordingly, there is a need for a method, apparatus, and system for determining whether a user intended to initiate or participate in communication sessions through analysis of the user's voice.

### SUMMARY OF THE INVENTION

Methods and apparatus for determining intent of an end-user in a communication session are provided herein. In some embodiments, a method determining intent of an end-user in a communication session through voice analysis may include establishing a voice communication session between a first user device and a second user device, performing a voice analysis process to determine whether the end-user intended to establish the voice communication session, and determining whether to permit voice communications over the established voice communication session based on the voice analysis process performed, wherein all voice communications from the first user device is prevented from being transmitted over the established voice communication session at least until the voice analysis process has completed.

In some embodiments, a method for determining intent of an end-user in a communication session may include sending or receiving a request to establish a voice communication session, requesting the end-user to provide a voiceprint authentication sample in response to sending or receiving the request to establish the voice communication session, performing a voice analysis process using the voiceprint authentication sample to determine whether the end-user wants to establish the voice communication session, and determining whether to establish the voice communication session based on results of the voice analysis process.

In some embodiments, an apparatus for determining intent of an end-user in a communication session may include at least one processor, at least one input device, and at least one storage device storing processor-executable instructions, which, when executed by the at least one processor, performs a method including establishing a voice communication session between a first user device and a second user device, performing a voice analysis process to determine whether the end-user intended to establish the voice communication session, and determining whether to permit voice communications over the established voice communication session based on the voice analysis process performed, wherein all voice communications from the first user device is prevented from being transmitted over the established voice communication session at least until the voice analysis process has completed.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of a communications system including a first terminal and at least one second terminal in accordance with one or more exemplary embodiments of the invention;

FIG. 2A is an illustration of an exemplary GUI for authenticating a user on a terminal in accordance with one or more embodiments of the invention;

FIG. 2B is an illustration of an exemplary GUI for authenticating a user on a terminal for a non-voice communication in accordance with one or more embodiments of the invention;

FIG. 3A is a flow diagram of an exemplary method for determining intent of an end-user in a communication session in accordance with one or more embodiments of the invention;

FIG. 3B is a flow diagram of another exemplary method for determining intent of an end-user in a communication session in accordance with one or more embodiments of the invention;

FIG. 4 is a flow diagram of an exemplary method for authenticating a user in accordance with one or more embodiments of the invention;

FIG. 5 is a flow diagram of an exemplary method for authenticating a user within an established communication session in accordance with one or more embodiments of the invention; and

FIG. 6 is a depiction of a computer system that can be utilized in various embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention are directed to methods, apparatus, and systems for authenticating a user for a communication session. The authentication provides confirmation of user intent as well as authentication a communication originates from a specific user. Alternative embodiments may use such voice analysis for confirming user intent of virtual payment systems to ensure purchases from a user device are intended by the user.

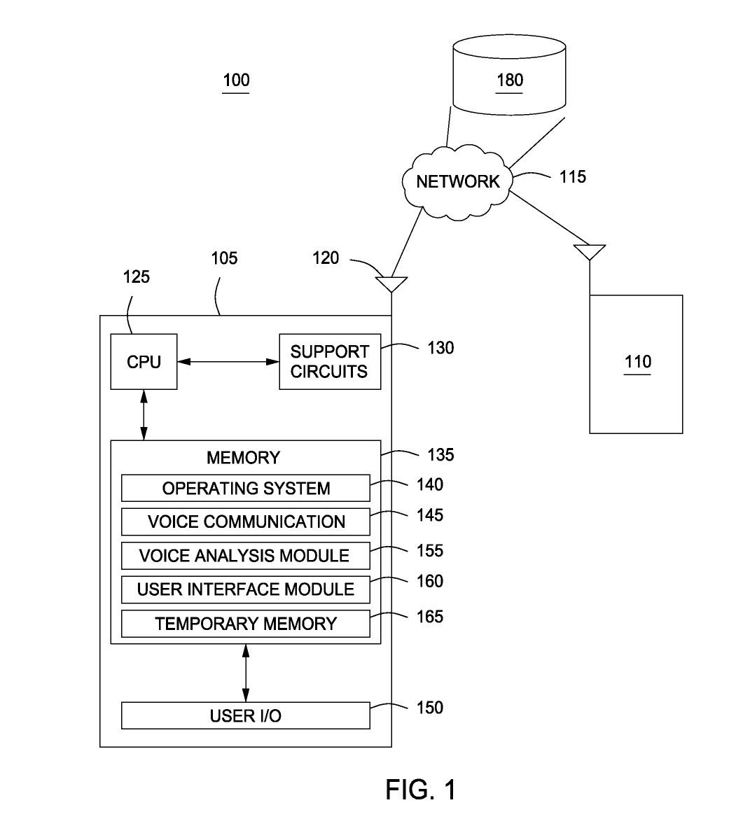

FIG. 1 is an illustration of a communications system 100 including a first terminal 105 and at least one second terminal 110 in accordance with one or more exemplary embodiments of the invention. The exemplary mobile communications system 100 comprises a communications network 115, the first terminal 105, and the second terminal 110. The two terminals are connected to the communications network 115 that may use Session Initiation Protocol (SIP), Voice over Internet Protocol (VoIP), and the like to form a voice call session. The connection may be wired or wireless. The communications network 115 may be one or more networks such as Internet Protocol (IP) networks or public switched telephone networks (PSTN) used to connect the first 105 and second terminals 110. The first and second terminals (105, 110) may be electronic user devices (e.g., telephones, personal computers, laptops, smart phones, mobile phones, tablets, and the like).

The communications network 115 allows for wireless mobile devices to exchange data and voice communications. The communications network 115 is capable of processing the sending and receiving of both and voice and data streams between the first terminal 105 and the second terminal 110. The first terminal 105 includes an antenna 120, a CPU 125, support circuits 130, memory 135, and input/output (I/O) interface 150. The support circuits 130 include circuits for interfacing the CPU 125 and memory 135 with the antenna 120 and input/output interface 150. The I/O interface 150 may include a speaker, microphone, camera, touch screen, buttons and the like for a user to interact with the first terminal 105.

The memory 135 includes an operating system 140, a communication module 145, a voice analysis module 155, a user interface module 160, and a temporary memory module 165. The operating system 140 controls the interoperability of the support circuits 130, CPU 125, memory 135, and the I/O interface 150. The user interface module 160 contains instructions for the I/O interface 150 to interact with the operating system 140 such as for a graphical user interface (GUI).

The voice analysis module 155 includes instructions for forming a communications session with a verified user. In some embodiments, the communication module 140 is responsible for encryption and decryption of voice transmissions between the first terminal 105 and the second terminal 110. In other embodiments, the voice analysis module 155 includes instructions to authenticate a voiceprint on the first terminal 105. The voice analysis module 155 in the first terminal 105 may authenticate the voiceprint on the first terminal 105 from the user of the first terminal 105. Alternatively, the voice analysis module 155 in the first terminal 105 may authenticate a voiceprint received from the second terminal 110.

In further embodiments, a voiceprint may be verified across the network 115 on a remote authentication server 180. In such embodiments, the remote authentication server 180 may store a pre-recorded sample of the user to compare a voiceprint sample. The remote authentication server 180 may also store previously selected user passphrases or answers to a questionnaire as further options to authenticate a user. Embodiments may thus use a combination of authentication voice methods to verify a user identity (e.g., a voice pattern comparison of a user speaking a specific passphrase). The server 180 may further comprise a database of voice samples linked to user accounts from all users accessing the network 115. Alternative embodiments may utilize user profiles in addition to voiceprint authentication samples that comprise passphrases and questionnaires.

Questionnaires may provide an additional authentication requirement when the user environment has excessive white noise that cannot be filtered out. In other embodiments, the questionnaire may be answered by touchtone in environments where voice verification is not possible (e.g., airport, or movie theater). In alternative embodiments, the questionnaire may be used in conjunction with voiceprint and passphrase authentication verification such that a communication session is allowed only when a user correctly answers a question with a spoken predetermined passphrase. Further embodiments still, are stored passphrase or keyword commands used to initiate or accept a communication session request. In some embodiments, participants in the communication session may be given an indication (e.g., graphical user interface (GUI) prompt, lighted indicator, and the like) whenever other participants in the communication session successfully pass authentication. In additional embodiments, multiple user profiles and voice patterns may be associated to a single end-user device, or terminal 105. Pre-associated voice patterns to multiple users allow a select group of people to use the terminal 105.

The voice communication module 145 may establish a secure communications session via cellular communication (CDMA, GSM, 3GPP, etc.). In some embodiments, after a voice communication session is established between the first and second terminals (105 and 110), the voice analysis module 155 may place the communication session on a temporary hold in response to a user initiation of a communication session or incoming communication session request. In the instance of voice communication sessions, the session may be placed on temporary hold. In some embodiments, at least one terminal is notified the call is on hold until user verification is complete.

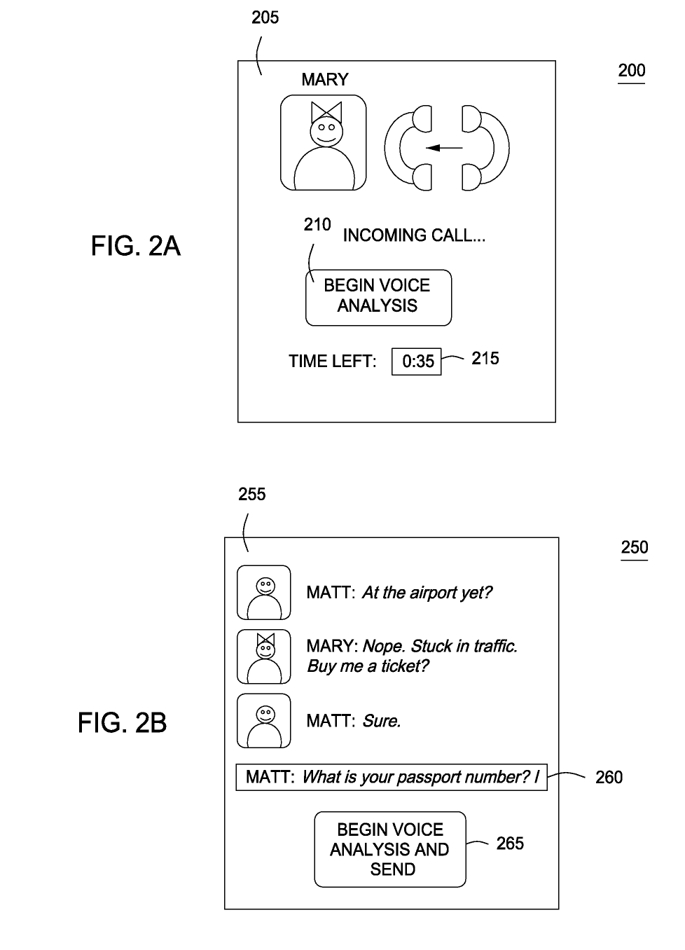

FIG. 2A is an illustration of an exemplary GUI 200 for authenticating a user on a terminal in accordance with one or more embodiments of the invention. The GUI 200 displays an incoming communication session request from another user 205. In this example, the communication session is a voice call, however other embodiments may include a video call or other real-time communications session. The GUI 200 further comprises a voice analysis button 210 and a timer 215. The voice analysis button 210 is selected on the terminal 105 to begin a voice pattern authentication process that will be further discussed below. In some embodiments, the authentication process may occur solely on the terminal 105, on a remote authentication server 180 over the network 115, or further still, a combination of the server 180 and terminal 105.

The timer 215 represents a limited amount of time the terminal 105 has to initiate or pass voice verification. If verification is not initiated or passed after expiration of the timer 215, the communication session will be terminated. In other embodiments, the incoming call may be directed to voice mail or other messaging service (e.g., text message, e-mail, and the like.). In such embodiments, the terminal 105 must also pass voice authentication in order to receive or view the message contents.

FIG. 2B is an illustration of an exemplary GUI 250 for authenticating a user on a terminal for a non-voice communication in accordance with one or more embodiments of the invention. The GUI 250 comprises a text messaging service identifying users 255 in a conversation. The GUI 250 further comprises a text entry field 260 and a voice analysis button 265. Any text entered into the text entry field 260 will not be sent until the voice analysis button 265 is selected and the voice of the user is authenticated. In this example, users of the network 115 will be ensured that text messages are indeed originating from a specified user. In some embodiments, once a voice is authenticated, messaging may continue uninterrupted for a fixed inactivity period (e.g., 2 minutes). In such embodiments, after an inactivity period, the next outgoing messaging requires voice verification.

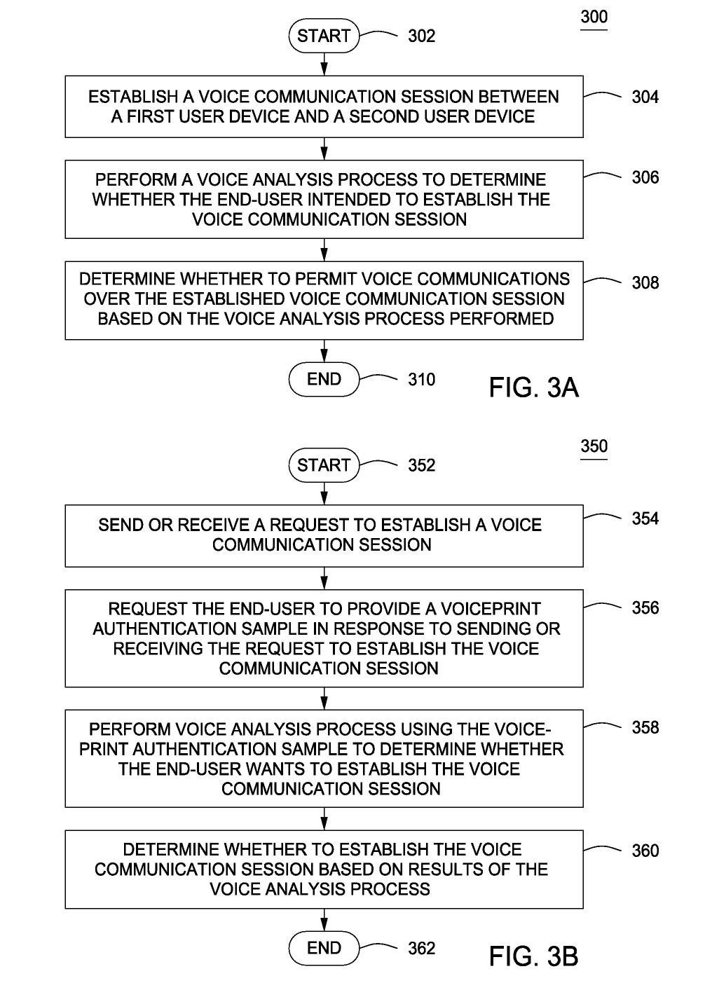

FIG. 3A is a flow diagram of an exemplary method 300 for determining intent of an end-user in a communication session in accordance with one or more embodiments of the invention. The method 300 begins at step 302 and continues to step 304 where a voice communication session is established between the first user device and a second user device. At 306, a voice analysis processes performed to determine whether the end-user intended to establish the voice communication session. For example, a call may be established between a first user device and the second user device. However, the end-user associated with the first device, for example, may not have intended to initiate or receive the call that established the voice communication session. Thus a voice analysis is performed on the end-user's voice to determine whether they actually intended to establish the voice communication session. In some embodiments, the voice analysis process may include sending a voiceprint sample to a remote authentication server via communications networks for comparison to previously sport voice sample by the end-user. In some embodiments the voice analysis process may include performing volume testing on the voiceprint sample to determine if the end-user intended to establish the voice communication session. In other embodiments, the voiceprint sample may be requested by the end-user, analyzed, and compared against the previously stored voice. In some embodiments the voice analysis process may further include analyzing the voiceprint sample using a predetermined passphrase.

At 308, it is determined whether to permit voice communications over the establish voice communication session based on the voice analysis process performed. In some embodiments, all voice communications from the first user device prevented from being transmitted over the establish voice communication session at least until the voice analysis process has completed. The method 300 then ends at 310.

FIG. 3B is a flow diagram of an exemplary method 350 for determining intent of an end-user in a communication session in accordance with one or more embodiments of the invention. The method 350 begins at step 352 and continues to step 354 where a request to establish a voice communication session is sent or received. At 356, the end-user is requested to provide a voiceprint authentication sample in response to sending or receiving the request to establish the voice communication session. At 358, a voice analysis process is performed using the voice print authentication sample to determine whether the end-user wants to establish the voice communication session. In some embodiments, when an incoming call request to establish voice communication session is received, the incoming call will be placed on hold until the voice analysis process has been performed. In some embodiments, the voice analysis process may include comparing the voiceprint authentication sample against previously stored voiceprint authentication sample. In some embodiments a match of the voiceprint authentication sample against the previously stored voiceprint authentication sample may be an indication that the end-user desires to establish the call. At 360, it is determined whether to establish the voice communication session based on the results of the voice analysis process. The method 350 ends at 362.

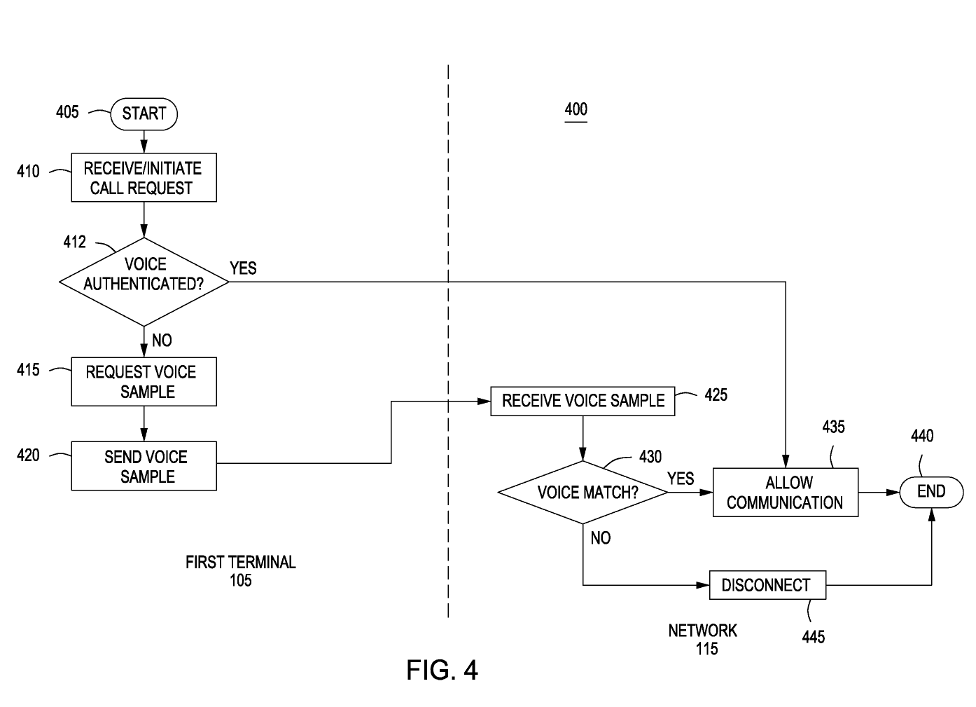

FIG. 4 is a flow diagram of an exemplary method 400 for authenticating a user in accordance with one or more embodiments of the invention. In the depicted embodiment, the method 400 comprises steps 405-420 on the first terminal and steps 425-440 on the network 115 and server 180. However, alternative embodiments may include the method 400 executed entirely on the first terminal 105.

The method 400 begins at step 405 and continues to step 410 wherein a communication session is request is received or initiated on the first terminal 105. In some embodiments, the communication session is established at step 410 but communication is temporarily prevented until the voice authentication process is complete. The method 400 continues to step 412 to determine whether the voice of the user has been recently analyzed and authenticated (e.g., within the past 10 minutes) on the first terminal 105. If true, the communication session is established or released to allow communication between the first terminal 105 and the second terminal 110 at step 435. Otherwise, the method 400 continues to step 415 and requests a voiceprint authentication sample on the first terminal 105. The sample may be a randomized word or phrase provided by the first terminal 105 or authentication server 180. In some embodiments, the phrase may be a specific predetermined passphrase previously spoken by the user. In some embodiments, the method 400 may always proceed to step 415 such that in every instance of communication session reception or initiation, a voice authentication is required.

The method 400 continues to step 420 wherein the voice sample is sent for voice comparison. At step 425, the voice sample is received for processing at a remote authentication server 180 and at step 430 the voice sample is compared against a previously stored user voice. In some embodiments, the voice sample may be analyzed locally on the first terminal 105. Optionally, the voice sample may be subjected to volume testing to determine whether the communication session is indeed sought to be established by a user. In other words, the method 400 is able to determine whether an inputted voice is deliberate. A louder voice indicating an intention to input a voice sample, and, a muffled low voice indicating an unintentional input.

In some embodiments, voice sampling may be verified in two phases: enrollment and verification. During enrollment, the voice sample is recorded and processed for a number of extracted features to form a voice print, template, or model. In the verification phase, a speech sample or “utterance” is compared against a previously created voice print. The enrollment phase may verify with free speech via text independent algorithms. Alternatively, text dependent verification may be applied wherein the user is required to speak a specific answer or passphrase. In such instances, where the text must be the same for enrollment and verification this is called text-dependent recognition. Prompts can either be common across all speakers (e.g.: a common pass phrase) or unique. In addition, the use of shared-secrets (e.g.: passwords and PINs) or knowledge-based information can be employed in order to require multiple authentication factors.

Processing and storing voice prints may be use frequency estimation, hidden Markov models, Gaussian mixture models, pattern matching algorithms, neural networks, matrix representation, Vector Quantization and decision trees by way of non-limiting example. Some embodiments include “anti-speaker” techniques, such as cohort models, and world models. Ambient noise levels may be minimized with noise reduction algorithms that also improve accuracy. Performance degradation can result from changes in behavioral attributes of the voice and from enrollment using one telephone and verification on another telephone (“cross channel”). Integration with two-factor authentication products is expected to increase. Voice changes due to aging may impact system performance over time. After each successful verification, some embodiments may capture such long-term changes in the voice.

If at step 430, there is no voice match found, the method continues to step 445 wherein the communication session is disconnected/denied and the method ends at step 440. However, if the voice matches the pattern of a previously stored voice sample of the user, step 435 allows communication and either establishes or releases the communication session. In addition to voice pattern recognition, the method 400 may also in other embodiments require a particular predetermined passphrase set by the user or network that is only known to the user. In some embodiments, multiple passphrases may be accepted. In further embodiments, a passphrase must be spoken and matched against a previously stored voiceprint of the user speaking the passphrase.

In further embodiments still, the voice authentication and voice sample may be automated within a delay period after a communication session is initiated. In such embodiments, the communication session is temporarily delayed (e.g., 3-4 seconds) while voice pattern recognition of a user will be automatically authenticated with the normal greeting of the user. The authentication in this instance may be matched against a previously recorded voice sample and/or passphrase greeting of the user. In such an embodiment, should the user pass authentication the same greeting sampled for authentication is allowed to pass through the communication channel to a recipient of the communication session. Thereafter, the communication session continues without a temporary delay. Such automated sampling allows for seamless security for the users of the network 115 and associated communication services.

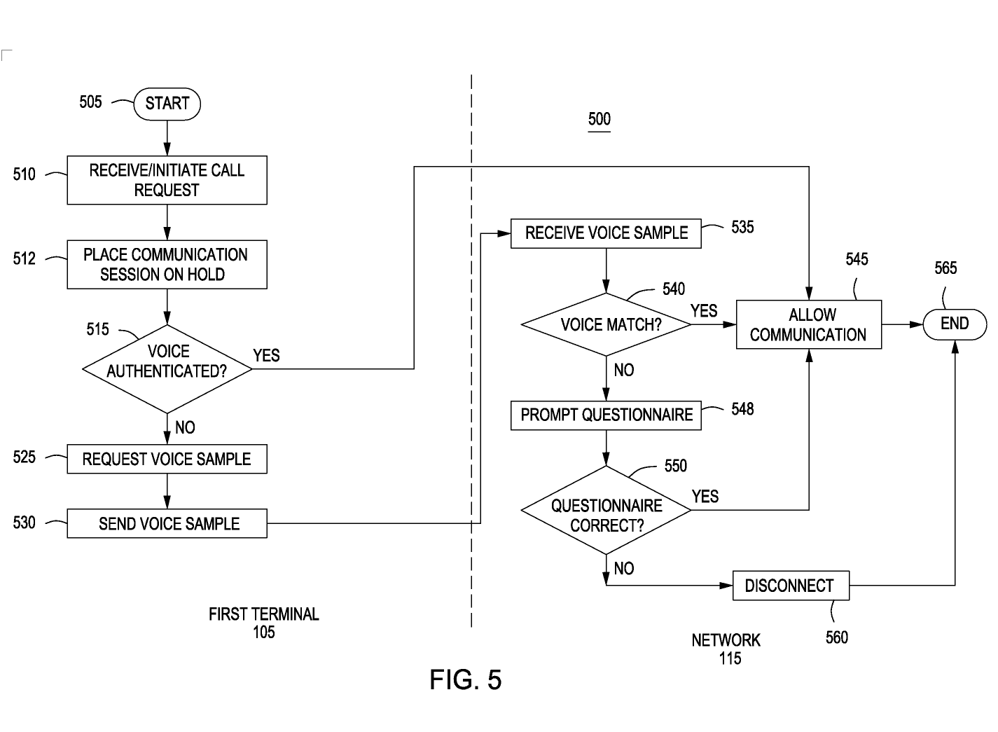

FIG. 5 is a flow diagram of an exemplary method for authenticating a user within an established communication session in accordance with one or more embodiments of the invention. In the depicted embodiment, the method 500 comprises steps 505-530 on the first terminal 105 and steps 535-565 on the network 115 and server 180. However, alternative embodiments may include the method 400 executed entirely on the first terminal 105.

The method 500 begins at step 505 and continues to step 510 wherein a communication session is request is received or initiated on the first terminal 105. The corresponding communication session is then placed on hold at step 512. The method 500 continues to step 515 to determine whether the voice of the user has been recently analyzed and authenticated (e.g., 10 minutes) on the first terminal 105. If true, the communication session is established or released to allow communication between the first terminal 105 and the second terminal 110 at step 545. Otherwise, the method 500 continues to step 525 and requests a voice sample on the first terminal 105. In some embodiments, the method 500 may always proceed to step 525 such that in every instance of communication session reception or initiation, requires a voice authentication. Next, the sample is sent at step 530 and received at a remote authentication server 180 at step 535.

Continuing to step 540 the voice sample is compared against the database of stored voice samples on the server 180. If a match is found, the method allows communication between the first and second terminals (105, 110) at step 545 and the method 500 ends at step 565. In some embodiments, more than one user may have an approved voice sample. For example, a family may prerecord or pre-authenticate a voice sample for every member of the family such that the first terminal 105 may be used by a specified group of people.

However, if the voice pattern of the voice sample does not match any of the previous stored voice samples, the method 500 may continue to a questionnaire at step 548. The questionnaire may comprise previously answered questions by the authenticated user and used to confirm the identity of the user. At step 550, the method 500 determines whether the answers provided are correct and if so, proceeds to allow communication at step 545. The questionnaire may be answered by speaking into the microphone of the first terminal 105 or input that is not reliant on speech recognition (e.g., touch tone). However, if the answer to the questionnaire is incorrect, the communication session is denied and disconnected at step 560 and the method 500 ends at step 565.

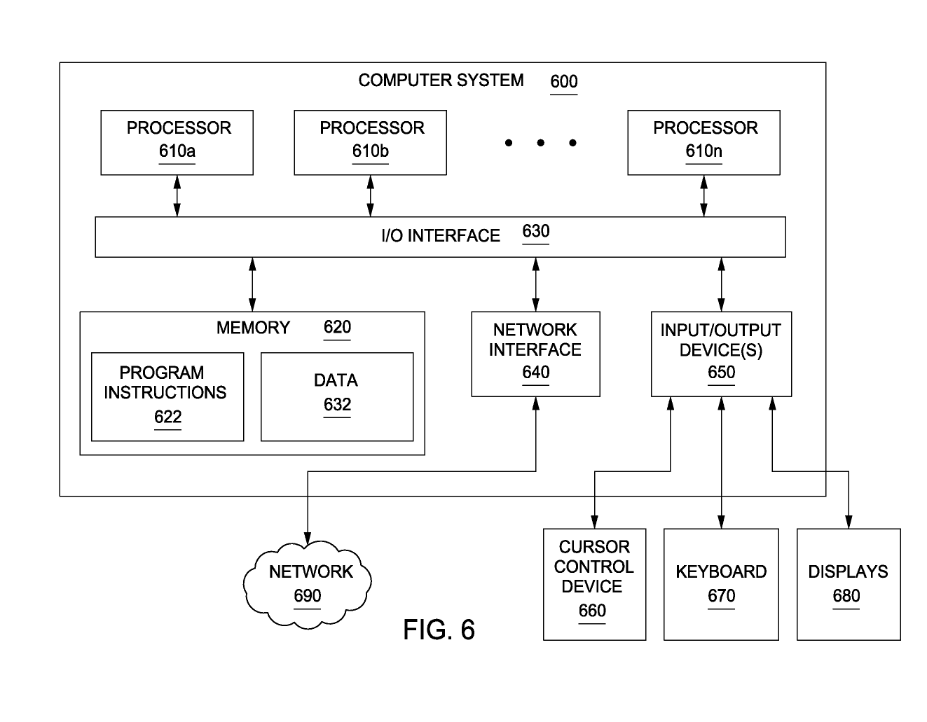

FIG. 6 is a depiction of a computer system 600 that can be utilized in various embodiments of the present invention. The computer system 600 comprises substantially similar structure comprising servers or electronic devices in the aforementioned embodiments.

Various embodiments of methods and system authenticating users for communication sessions, as described herein, may be executed on one or more computer systems, which may interact with various other devices. One such computer system is computer system 600 illustrated by FIG. 6, which may in various embodiments implement any of the elements or functionality illustrated in FIGS. 1-5. In various embodiments, computer system 600 may be configured to implement methods described above. The computer system 600 may be used to implement any other system, device, element, functionality or method of the above-described embodiments. In the illustrated embodiments, computer system 600 may be configured to implement methods 400, and 500 as processor-executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In some embodiments, the keyboard 670 may be a touchscreen input device.

In various embodiments, any of the components may be utilized by the system to authenticate a user as described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, cellular networks, Wi-Fi, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 650 may, in some embodiments, include one or more display terminals, keyboards, keypads, touchpads, touchscreens, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the methods described above, such as the methods illustrated by the flowchart of FIGS. 4 and 5. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, smartphones, tablets, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A method for determining intent of an end-user in a communication session comprising:
establishing a voice communication session between a first user device and a second user device;
performing a voice analysis process to determine whether the end-user intended to establish the voice communication session; and
determining whether to permit voice communications over the established voice communication session based on the voice analysis process performed, wherein all voice communications from the first user device is prevented from being transmitted over the established voice communication session at least until the voice analysis process has completed.

2. The method of claim 1, wherein the voice analysis process further comprises sending a voiceprint sample to a remote authentication server via a communications network for comparison to a previously stored voice sample.

3. The method of claim 2, wherein the method further comprises performing volume testing on the voiceprint sample.

4. The method of claim 1, wherein the voice analysis process includes
requesting a voiceprint sample;
analyzing the voiceprint sample; and
comparing the voiceprint sample against a previously stored voice sample.

5. The method of claim 4, wherein determining a comparison match of the previously stored voice sample indicates an identity of a user is verified as authorized for communication on the user device and establishing the voice communication session.

6. The method of claim 4, wherein the voice analysis process further includes analyzing the voiceprint sample using a pre-determined passphrase.

7. The method of claim 6, wherein the analysis is configured to accept one of at least two pre-determined passphrases.

8. The method of claim 1, wherein the method further comprises prompting with an automated multiple choice questionnaire wherein only one verbal passphrase is accepted to authorize the user device to establish a voice communication session.

9. A method for determining intent of an end-user in a communication session comprising:
sending or receiving a request to establish a voice communication session;
requesting the end-user to provide a voiceprint authentication sample in response to sending or receiving the request to establish the voice communication session;
performing a voice analysis process using the voiceprint authentication sample to determine whether the end-user wants to establish the voice communication session; and
determining whether to establish the voice communication session based on results of the voice analysis process.

10. The method of claim 9, wherein an incoming call request to establish the voice communication session is received, and wherein the incoming call is placed on hold until the voice analysis process is performed.

11. The method of claim 9, wherein the method further comprises performing volume testing on the voiceprint authentication sample.

12. The method of claim 11, wherein the voice analysis process includes:
comparing the voiceprint authentication sample against a stored previously provided voiceprint authentication sample from the end-user.

13. The method of claim 12, further comprising:
determining that the end-user wants to establish the voice communication session based on the comparison; and
establishing the voice communication session.

14. The method of claim 12, further comprising:
determining that the end-user does not want to establish the voice communication session based on the comparison; and
providing an indication to the end-user that the voice communication session will not be established.

15. The method of claim 9, wherein the voice analysis process includes:
sending the voiceprint authentication sample to an authentication server; and
receiving a determination as to whether the end-user wants to establish the voice communication session.

16. The method of claim 9, wherein the voice analysis process further includes performing voiceprint analysis using a pre-determined passphrase.

17. An apparatus for determining intent of an end-user in a communication session comprising:
a) at least one processor;
b) at least one input device; and
c) at least one storage device storing processor-executable instructions which, when executed by the at least one processor, performs a method including:
establishing a voice communication session between a first user device and a second user device;
performing a voice analysis process to determine whether the end-user intended to establish the voice communication session; and
determining whether to permit voice communications over the established voice communication session based on the voice analysis process performed, wherein all voice communications from the first user device is prevented from being transmitted over the established voice communication session at least until the voice analysis process has completed.

18. The apparatus of claim 17, wherein the voice analysis process includes
requesting a voiceprint sample;
analyzing the voiceprint sample; and
comparing the voiceprint sample against a previously stored voice sample.

19. The apparatus of claim 18, wherein determining a comparison match of the previously stored voice sample indicates an identity of a user is verified as authorized for communication on the user device and establishing the voice communication session.

20. The apparatus of claim 18, wherein the method further comprises performing volume testing on the voiceprint sample.
